(19) United States
(12) Patent Application Publication
(10) Pub. No.: US 2001/0031067 A1
(43) Pub. Date: Oct. 18, 2001

(54) 2-D/3-D recognition and tracking algorithm for soccer application

(76) Inventors: Howard J. Kennedy JR., Hamilton Square, NJ (US); Yi Tan, Plainsboro, NJ (US)

Correspondence Address: STERNE, KESSLER, GOLDSTEIN & FOX P.L.L.C., Attorneys at Law, Suite 600, 1100 New York Avenue, N.W., Washington, DC, 20005-3934, US

(21) Appl. No.: 09/734,710

(22) Filed: Dec. 13, 2000

Related U.S. Application Data
(60) Provisional application No. 60/170,394, filed on Dec. 13, 1999.

(51) Int. Cl. G06K 9/00

(52) U.S. Cl. 382/103; 382/154

(57) ABSTRACT

A method is provided for deriving three-dimensional camera viewpoint information from a two-dimensional video image of a three-dimensional venue captured by a camera. The method includes the steps of identifying a two-dimensional geometric pattern in the two-dimensional video image, measuring the two-dimensional geometric pattern, and calculating the three-dimensional camera viewpoint information using the measurements of the two-dimensional geometric pattern. The two-dimensional geometric pattern may be an ellipse that corresponds to a circle in the three-dimensional venue, such as the center circle in a soccer field. The three-dimensional camera viewpoint information is provided to a tracking program, which uses the information to track the two-dimensional geometric pattern, or other objects, in subsequently-captured video images.

### CROSS-REFERENCE TO RELATED APPLICATIONS

This application claims priority to provisional U.S. Provisional Patent Application No. 60/170,394, entitled “2-D/3-D Recognition/Tracking Algorithm for Soccer Application,” filed Dec. 13, 1999, the entirety of which is incorporated by reference herein.

### STATEMENT REGARDING FEDERALLY-SPONSORED RESEARCH AND DEVELOPMENT

Not applicable.

### REFERENCE TO MICROFICHE APPENDIX/SEQUENCE

LISTING/TABLE/COMPUTER PROGRAM LISTING APPENDIX (submitted on a compact disc and an incorporation-by-reference of the material on the compact disc) Not applicable.

### BACKGROUND OF THE INVENTION

1. Field of the Invention

This invention relates to a method for ascertaining three-dimensional camera information from a two-dimensional image. More specifically, the invention relates to a method for ascertaining three-dimensional camera information from the projection of a two-dimensional video image of an identifiable geographic shape.

2. Background Art

In three-dimensional (3-D) venues, three-dimensional tracking provides superior accuracy over two-dimensional tracking. Three-dimensional venues are venues such as stadiums which exist in three dimensions, but which may only be treated computationally by interpreting two-dimensional data from a camera image using operator-provided knowledge of the perspective and position of objects and planes within the field of view of a camera.

Because a two-dimensional image is a three-dimensional scene projection, it will by necessity carry the property of perspective. In other words, the dimensions of objects in the image depends on its distance to the camera, with closer objects appearing larger, and far away objects appearing smaller. Also, when the camera moves, different parts of the image will show different motion velocity since their real positions in the three-dimensional world are at varying distances from the camera. A true transformation must include perspective in order to link the different parts of the image to the different parts of the scene in the three-dimensional world.

Image tracking techniques such as landmark tracking and C-TRAK™ operate practically in a two-dimensional image space, as they deal with image pixels in a two-dimensional array. It is known that the formation of the two-dimensional image is the projection of a three-dimensional world. A conventional modeling method simplifies the transformation as from one plane to another, or as a two-dimensional to two-dimensional transformation. This type of transformation is referred to as an Affine transformation. Although the Affine method simplifies the modeling process, it does not generate precise results.

The advantage of perspective modeling is to provide high tracking precision and true three-dimensional transformation. With true three-dimensional transformation, each pixel of the image is treated as a three-dimensional projected entity. The tracking process can thus interpret the two-dimensional image as the three-dimensional scene and can track separate three-dimensional entities under a single transformation with high precision.

Accordingly, three-dimensional tracking provides superior accuracy as compared to two-dimensional tracking in three-dimensional venues because three-dimensional tracking takes into account perspective distortion. Two-dimensional tracking, or tracking in image space, does not have access to perspective information. Thus, three-dimensional target acquisition in theory produces fewer acquisition errors, such as missed positives and false positives.

However, three-dimensional target acquisition is computationally expensive. An example of three-dimensional target acquisition utilizes camera sensor data in addition to distance to and orientation of planes of interest within a three-dimensional venue (e.g., a stadium). The latter values may be acquired, for example, using laser range finders, infrared range finders or radar-like time of flight measurements. Automated range finders in cameras provide a simple example of a device for acquiring the distance necessary for three-dimensional target acquisition. Often, two-dimensional target acquisition is the only economical means of acquisition.

A conventional tracking system may consists of a two-dimensional target acquisition module coupled to a three-dimensional tracking module. However, this coupling necessitates a mathematical transition from potentially ambiguous two-dimensional coordinates to unique three-dimensional coordinates.

One coordinate system for representing a camera's viewpoint in three-dimensional space includes a camera origin plus camera pan, tilt and the lens focal length. The camera origin indicates where the camera is situated, while the other parameters generally indicate where the camera is pointed. The lens focal length refers to the lens “image distance,” which is the distance between the lens and the image sensor in a camera. Additional parameters for representing a camera's viewpoint might include the optical axis of the lenses and its relation to a physical axis of the camera, as well as the focus setting of the lens.

In some instances, it becomes necessary to interpret a video image in the absence of data about a camera's viewpoint. For example, information about the camera pan, tilt or lens focal distance may not be available. In such cases, it would be beneficial to be able to derive this information from the two-dimensional image itself. Once the viewpoint information is derived, a tracking process can interpret two-dimensional images as a three-dimensional scene and can track separate three-dimensional entities under a single transformation with high precision.

### BRIEF SUMMARY OF THE INVENTION

The present invention is directed to a method for deriving three-dimensional camera viewpoint information from a two-dimensional video image of a three-dimensional venue captured by a camera. The method includes the steps of identifying a two-dimensional geometric pattern in the two-dimensional video image, measuring the two-dimensional geometric pattern, and calculating the three-dimensional camera viewpoint information using the measurements of the two-dimensional geometric pattern. In embodiments, the two-dimensional geometric pattern is an ellipse that corresponds to a circle in the three-dimensional venue. In further embodiments, the three-dimensional camera viewpoint information is provided to a tracking program, which uses the information to track the two-dimensional geometric pattern, or other objects, in subsequently-captured video images.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows the projection of a model ellipse onto the central circle of a soccer field in accordance with an embodiment of the present invention.

FIG. 2 shows an example three-dimensional world reference coordinate system used in an embodiment of the present invention.

FIG. 3 depicts a pin-hole model used to approximate a camera lens in an embodiment of the present invention.

FIG. 4 depicts a side view of a central circle projection in accordance with an embodiment of the present invention.

FIG. 5 depicts an example of a visual calibration process in accordance with an embodiment of the present invention.

FIG. 6 depicts an example of a computer system that may implement the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

1. Overview of the Invention

The invention utilizes a two-dimensional projection of a well-known pattern onto an image plane to infer the orientation and position of the plane on which the well-known pattern is located with respect to the original of the image plane. It should be noted that, in general, there is not a one-to-one correspondence between a two-dimensional projection and the location of the camera forming that two-dimensional projection because, for instance, camera zoom produces the same changes as a change in distance from the plane. The present invention defines and makes use of practical constraints and assumptions that enable a unique and usable inference of orientation and position to be made from a two dimensional projection.

Although the discussion that follows focuses on a circular pattern on a plane, the methods described herein can also be used for any known geometrical object located on a plane.

Once a two-dimensional projection has been used to provide a working three-dimensional model of the camera and its position in relation to the venue, that model can be used to initiate other methods of tracking subsequent camera motion such as, but not limited to, three-dimensional image processing tracking.

It has been observed that, together, camera viewpoint information and some physical description of a three-dimensional viewpoint can be used to predict or characterize the behavior of a two-dimensional image representation of a three-dimensional scene which the camera “sees” as the camera pans, tilts, zooms, or otherwise moves. The ability to predict the behavior of the two-dimensional image facilitates the interpretation of changes in that image.

2. Soccer Pattern Recognition in Two-Dimensional Image

Search Target in Soccer Central Field

The center of a soccer field is a standard feature that appears in every soccer venue whose dimensions are set by the rules of the game. It is defined as a circle with a radius of 9.15 m (10 yds) centered on the mid-point of the halfway line. Because it is always marked on a soccer field, this feature can be used as the target for a recognition strategy.

Both recognition and landmark tracking utilize features extracted from the projection of the center field circle on to the plane of the image. The recognition or search process first detects the central line, then looks for the central portion of the circular arcs. For example, this may be done using techniques such as correlation, as described in detail in U.S. Pat. No. 5,627,915, or other standard image processing techniques including edge analysis or Hough transformation.

The projection of the circle onto an imaging plane can be approximately represented by an ellipse. One technique for recognizing the center circle is to detect the central portion of the nearly elliptical projection, or, in other words, the portion that intersects with the center line. Using these points and knowledge of the expected eccentricity of the ellipse, acquired from a training process, the process generates an expected or hypothetical ellipse. It then verifies or rejects the hypotheses by using massive measuring points along the hypothesized ellipse.

Model-Based Search

The perspective projection of the soccer field center circle is approximated as an ellipse. The parameters of the elliptical function are used to define the model to represent the circle. In the model, the eccentricity of the ellipse, which is the ratio of the short axis to the long axis, is a projective invariant with respect to a relatively fixed camera position. Accordingly, it is used for target feature match and search verification.

To adapt the recognition system to different venues and different camera setups within a given venue, a model training process is established. In the training process, four points of the ellipse are selected from the input image and the model is extracted and stored to serve the search process. This extraction can be done by a human operator making measurements on an image of the center circle from the camera's point of view. This data can be acquired ahead of the game. It can also be obtained in real time and refined during the game.

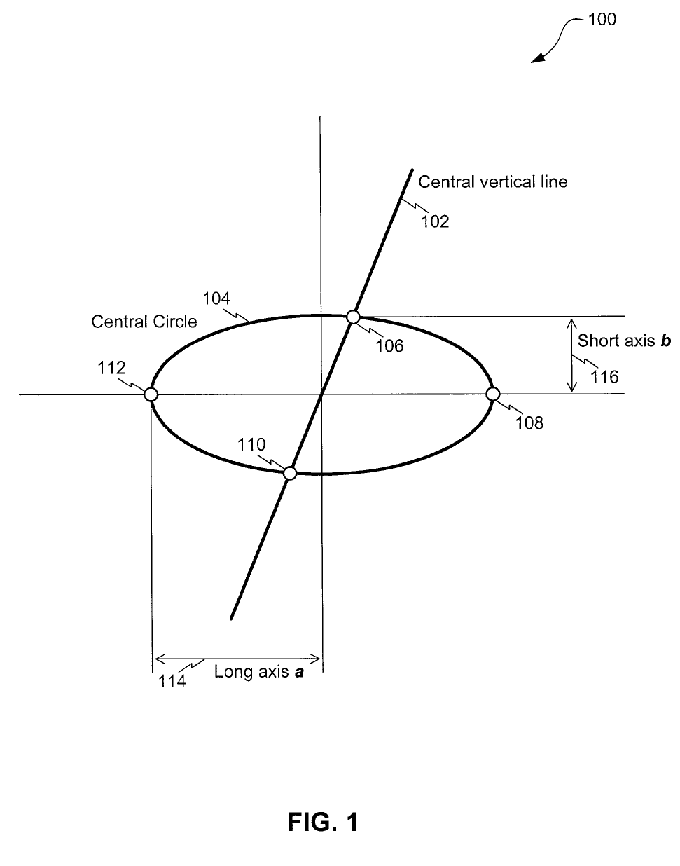

FIG. 1 shows the projection of a model ellipse onto the central circle of a soccer field in accordance with an embodiment of the present invention. As seen in FIG. 1, the elliptical model 104 of the central circle intersects the central vertical line 102, as discussed above. The four points 106, 108, 110 and 112 of the ellipse are extracted by the training process. As also depicted in FIG. 1, the model ellipse 104 includes a long axis a 114 and a short axis b 116. The ratio of the short axis b 116 to the long axis a 114 defines the eccentricity of the model ellipse 104.

Center Vertical Line Search, Measurement and Fitting

Multiple sub-region horizontal correlation scans are performed on the image to detect the segments of the projected soccer field central line. Line parameters, including the slope and offset in image coordinates, are computed for every pair-wised segment and the final line fitting is obtained by dominant voting from the whole set of line segment parameters.

Circular Arc Search and Fitting

A circular arc is searched for along the detected central line from the top of the image to the bottom. Multi-scaled edge-based templates are used to correlate the search region to find the best matches. A group of good matches are selected as candidates, along with their vertical position y, to represent the circular arcs. The selection of the candidates is based on match strength, the edge structure of the line segment, and the local pixel contrast.

Match Hypothesis Making and Verification

The pair-wise combination of circular arc candidates will form a group of ellipse hypotheses. Each hypothetical elliptical function is calculated by using the elliptical model provided by the training process. Each elliptical hypothesis is then verified by 200-point measurements along the computed circular arc, distanced by the method of even angular division. The verification process includes point position prediction, intensity gradient measurement, sub-pixel interpolation, and final least-mean-square function fitting on the 200-point measurements. The first candidate that can pass the verification process is used to define the camera pan, tilt and image distance (PTI) model and to determine a logo insertion position or to initialize a tracking process. If no candidate can pass the verification process, then the search fails in finding the target in the current image.

3. Modeling 3-D Camera PTI from 2-D Projection

Assumptions

To transform the two-dimensional image recognition features into a three-dimensional camera pan, tilt and image distance (zoom) or PTI model, the following assumptions are made: (1) that the camera is positioned near the central field; (2) that during the live event the camera position remains relatively unchanged; and (3) that the approximate distance from camera to soccer field center circle is known.

3-D World Reference Coordinate System

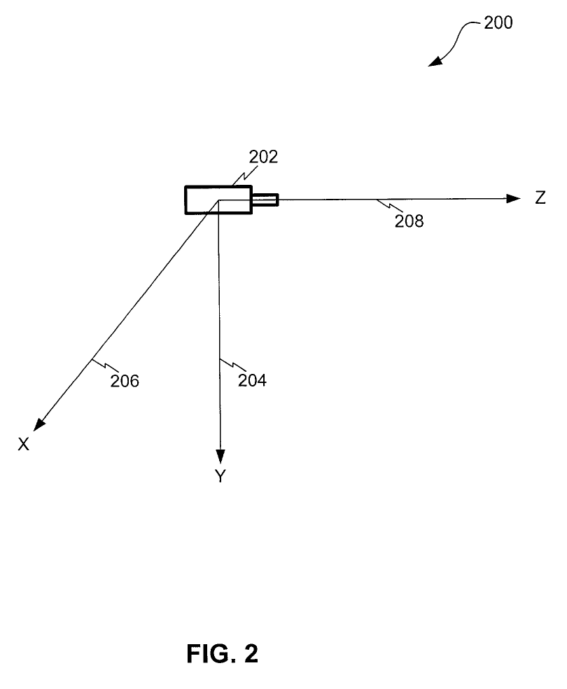

As shown in FIG. 2, the origin of a three-dimensional world reference coordinate system (X=0, Y=0, Z=0) is aligned with a camera stand 202. Camera rotation along the Y-axis 204 is defined as pan, camera rotation along the X-axis 206 is defined as tilt, and camera rotation along the Z-axis 208 is defined as roll.

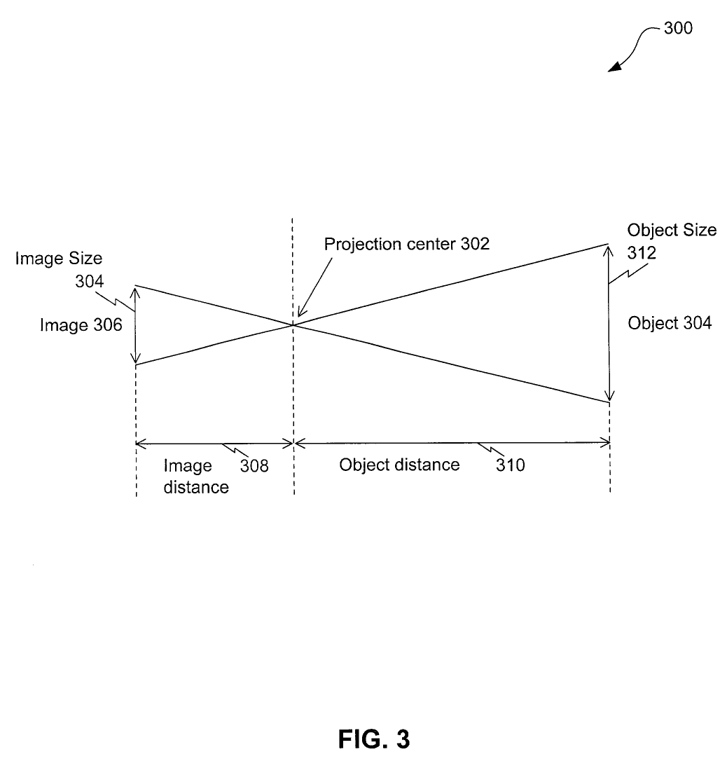

The first order approximation of camera lens is a pin-hole model. An example pin-hole model 300 is shown in FIG. 3. As shown in FIG. 3, the object 304 is an object distance 310 away from a projection center 302. The image 306 is an image distance 308 away from the projection center 302. The object 304 has an object size 312 and the image 306 has an image size 314. From this model the image distance (i.e., the distance from center of the projection to the image sensor), which determines the zoom scale, can easily be calculated by using triangle similarity:

Image distance=Object distance*Image size/Object size

Or, in the case of the pin-hole model 300, the image distance 308 equals the object distance 310 times the image size 314 divided by the object size 312.

PTI Computation

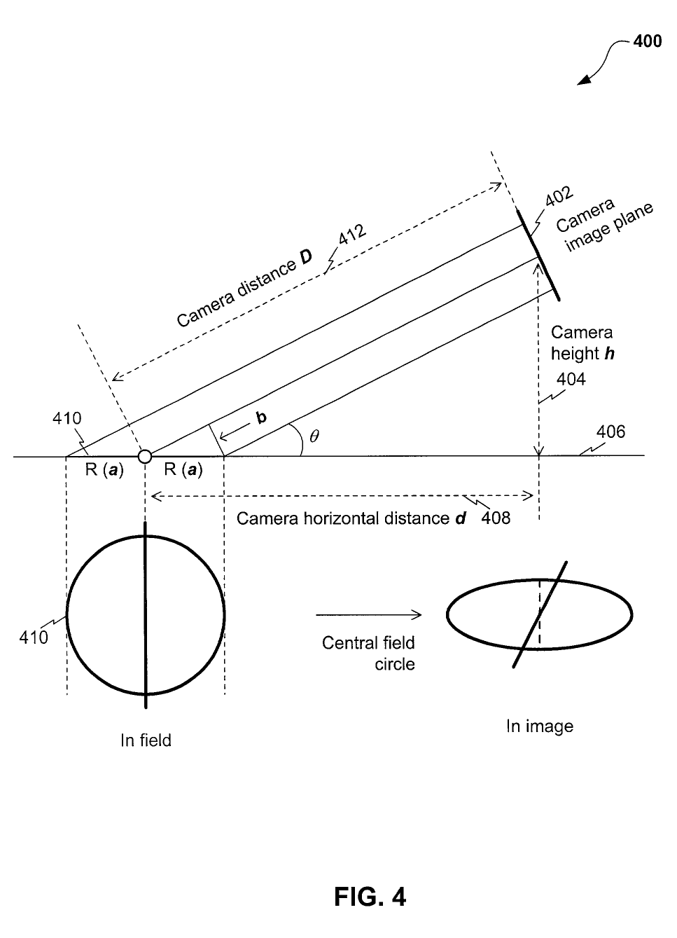

The minimal requirement to compute the camera pan, tilt and image distance is to know the physical dimensions of the radius of the central circle r, and the distance D from camera stand to circle center in the field. The camera projection angle θ can be calculated from measured image elliptical parameters. When θ and distance D are available, the physical distance and height of the camera to the soccer field circle center are easily calculated, as shown in FIG. 4.

FIG. 4 depicts a side view of a central circle projection in accordance with an embodiment of the present invention. As shown in FIG. 4, the camera image plane 402 is at a height h 404 above the plane of the playing field 406. The camera imaging plane 402 is also at a horizontal distance d 408 from the center of the central circle 410. The camera image plane 402 is also a camera distance D 412 from the center of the central circle 410. The central circle 410 is shown both from a side view and a top view for the sake of clarity. The camera projection angle θ is shown as the angle created between the playing field 406 and a line perpendicular to the camera image plane 402.

The image ellipse parameters can be obtained from a search process, which includes the ellipse center coordinate position (x0, y0) and long/short axes (a, b).

From FIG. 4, the camera projection angle θ can be calculated by the ellipse's eccentricity:

θ=arcsin(b/a)

With the known camera distance D and the projection angle θ, the camera's height and horizontal distance are calculated as:

d=D* cos θ

h=D* sin θ

The pan, tilt, and image distance parameters are then calculated as:

Image distance I=α*D*γ/r.

Pan P=Φ+dp.

Tilt T=θ+dt.

dp=arctan((x0−center x of the image plane)*γ/I).

dt=arctan(y0−center y of the image plane)*γ/I).

The image distance I is computed using the long axis value, α, the distance D from the camera stand to the center of the circle in the field, the radius of the central circle, r, and a factor γ, which is a scalar factor used to convert image pixels into millimeters.

The camera pan P is composed of two parts. The first part, 101 , is the fixed camera pan angle with respect to the center field vertical line. If the camera is aligned with the central line, Φ is zero. Otherwise, Φ will be determined by the camera x position offset from the central line. The initial value of Φ is set to be 0 and a more precise value can be obtained through the use of a visual calibration process as described in next section. The second part, dp, is the incremental change of camera pan angle motion. This value is determined using the circle center x position with respect to image frame-center x coordinate, the image distance, I, and the scalar factor γ.

Camera tilt T is also composed of two parts. The first part, θ, is the overall camera tilt projection angle towards the center of field circle. As described above, θ may be obtained using the eccentricity value of the ellipse detected in the image. The second part, dt, is the incremental change in camera tilt motion. This value is determined using the circle center y position with respect to image frame-center y coordinate, the image distance, I, and the scalar factor γ.

Calibration Process

As discussed above, due to the fact that camera x position may not align exactly with the field central line, Φ needs to be calculated in order to render a precise pan value, P. This may be accomplished via a visual calibration process, or it may be accomplished using an automated feedback process.

The calibration process begins with an initial pan, tilt and image distance (PTI) model, which assumes that the camera x position offset equals zero. The process then uses this data to calculate the projection of the central circle, its bounding box (a square), as well as the location of the central vertical line on the present image.

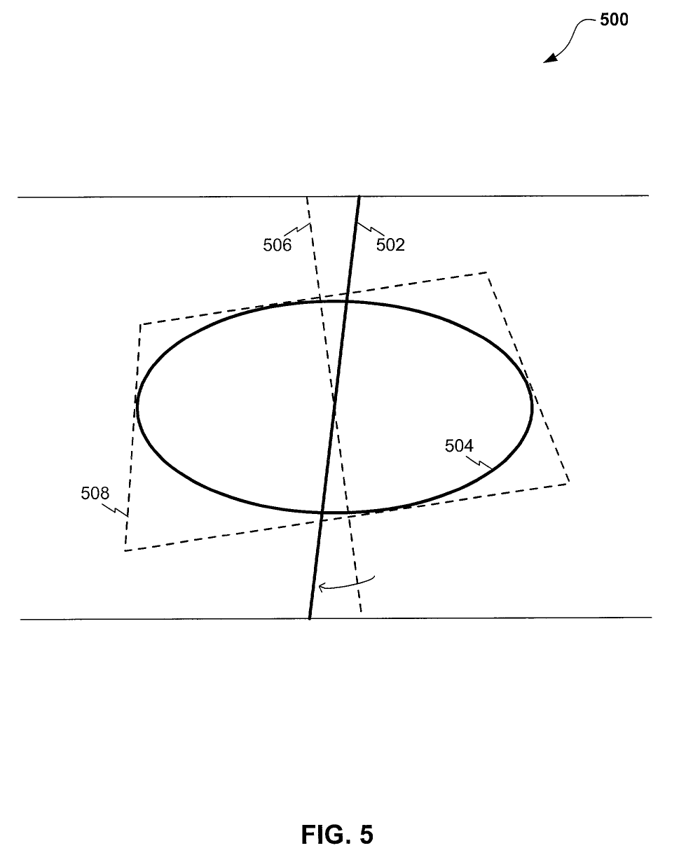

In the case where the calibration process comprises a visual calibration, the projections are graphically overlaid onto the image and visually compared to the field circle ellipse formed by the camera lens projection. If the two overlay each other well, the initial PTI model is accurate and there is no need to calibrate. On the other hand, additional calibration may need to be performed in order to make a correction. A camera x position offset control interface is provided to make such changes. An example of the visual calibration process is shown in FIG. 5, where the solid lines are image projections of the central circle 504 and the central verticle line 502, and the dashed lines are the graphics generated by PTI model, which in this case include a projection of the central line 506, and a bounding box 508 around the central circle.

In the case where the calibration process comprises an automatic calibration, the adjustment is performed automatically using an iterative feedback mechanism which looks for the actual line, compares the projected line to the actual line, and adjusts the PTI parameters accordingly.

In order to calibrate the pan value P, the additional offset dx must be added to or subtracted from the camera x position and the pan angle Φ must be recalculated as follows:

Φ=arctan(dx/d).

We then update the pan value P with the newly calculated Φ, recalculate the projection and redisplay the result. If the projected vertical line aligns exactly with the image central line, P is calibrated. The process is iterated until alignment is achieved.

To calibrate the tilt value T, a small amount dh is added to or subtracted from the camera height h, keeping the horizontal distance d unchanged. The camera projection angle θ is recalculated as:

θ=arctan((h+dh)/d).

We then update the tile T with the newly calculated θ, recalculate the projection and redisplay the overlay. If the projected top/bottom boundary of the square subscribe the image ellipse exactly, then T is calibrated.

4. Transition to 3-D Tracking

Once the PTI model has been obtained, a tracking process may be initialized, including, but not limited to landmark tracking based on the ellipse, C-TRAK™ (a trademark of Princeton Video Image of Lawrenceville, N.J.) tracking, or a hybrid tracking process.

Ellipse (Landmark) Tracking

Landmark tracking refers to a tracking method that follows a group of image features extracted from the view of a scene such that these features will most probably appear in the next video frame and will preserve their properties in the next frame if they appear. For instance, if there is a house in an image, and there are some windows and doors visible on the house, the edges and comers of the windows and doors can be defined as a group of landmarks. If, in the next video frame, these windows or doors are still visible, then the defined edges or corners from the previous image should be found in a corresponding position to the current image. Landmark tracking includes the methods for defining these features, to predict where these features will appear in the future frames, and to measure these features if they appear in the upcoming images.

The result of landmark tracking is the generation of a transformation, which is also called a model. The model is used to link the view in the video sequence to the scene in the real world.

In the case of a soccer application, the central circle and the central line are used as the landmarks for scene identification and tracking. When the camera moves, the circle may appear in a different location, but its shape will be preserved. By tracking the circle, the transformation or model between the view and the scene of the real world may be derived. This model can be used to serve for the continuation of tracking or for any other application purpose, including, but not limited to, the placement of an image logo in the scene.

In accordance with an embodiment of the present invention, the three-dimensional PTI model generated according to the methods described above is used to achieve landmark tracking. The PTI model is used to calculate 200 measurement positions along the projected central circle in every image frame. These positions are measured with sub-pixel high precision. The difference errors between the model predictions and the image measurements are fed into least-mean-square optimizer to update the PTI parameters. The continuously updated PTI model tracks the motion of camera and provides the updated position for applications such as logo insertion.

Transition to C-TRAK™

C-TRAK™ refers to an alternate tracking method. Like landmark tracking, C-TRAK™ is used to follow the camera motion and track scene changes. However, C-TRAK™ does not depend on landmarks, but instead tracks any piece of the video image where there is a certain texture available. According to this process, a group of image patches that have a suitable texture property are initially selected and stored as image templates. In subsequent images, a prediction is made as to where these image patches are located and a match is attempted between the predicted location and the stored templates. Where a large percentage of matches are successful, the scene is tracked, and a model may be generated that links the image view to the real world.

In an embodiment of the present invention, the ellipse (landmark) tracking process will warm up the C-TRAK™ processing when the set of transition criterion (both timing and image motion velocity) is met. Because C-TRAK™ tracking has a limited range, it relies on historic motion which has to be acquired from two or more fields. After the transition is made, C-TRAK™ will take over the tracking control and update the PTI model thereafter.

Hybrid Tracking

The transition from landmark tracking to C-TRAK™ tracking is dependent upon the camera motion. Because C-TRAK™ accommodates only a limited rate of motion, there are cases where no transition can occur. However, for most typical motion rates, the transition may take anywhere from a second to a full minute. Because C-TRAK™ is only relative as opposed to absolute (i.e., it can keep an insertion in a particular place), it cannot improve the position of an insert with respect to fixed elements in the venue.

According to an embodiment of the present invention, during the transition period, the system operates in a hybrid mode in which the landmark tracking is used to improve the absolute position while C-TRAK™ is being used to maintain fine scale positioning. The tracking process uses a hybrid of landmark and texture based tracking modules. The unified PTI model is transferred between the two whenever the transition occurs. This also permits switching back and forth between the two modes or methods of tracking in, for instance, the situation when C-TRAK™ fails because of increased velocity.

Within the C-TRAK™ process, multiple sets of dedicated landmarks are defined in three-dimensional surface planes that correspond to the three-dimensional environment of the venue. These dedicated landmarks are assigned a higher use priority whenever the tracking resources are available. The presence of 3-D planes in the current image is continuously monitored by PTI model. The information is used for a tracking control process to decide which plane currently takes the dominant view in the image and thus to choose the set of dedicated landmarks defined in that plane for the purposes of tracking. The switch of landmark sets from one plane to the other is automatically triggered by an updated PTI so that the tracking resources can be efficiently used.

After the dedicated landmarks assume the tracking positions, the C-TRAK™ process will place the rest of tracking resources to randomly selected locations where the image pixel variation is the key criteria to control the selection of the qualified image tracking-templates.

Other Embodiments

Although the invention has been described with respect to soccer, it is equally applicable to other sports and venues. For instance, in baseball, the natural gaps between the pads can be used as distinct patterns to establish the three-dimensional camera model with respect to the back wall. Other landmarks such as the pitcher's mound or the marking of the bases can also be used to establish the three-dimensional model. In football, the goal post is a unique structure whose two-dimensional projection can be used to establish the three-dimensional correspondence. In tennis, the lines or marking on the tennis court provide good image features whose two-dimensional projections can be used in a similar manner. In other situations, distinct patterns may be introduced into the scene or venue to facilitate the process. For instance, in a golf match or a rock concert, a replica of a football goal post may be put in place to allow recognition and determination of a usable 3-D model.

Example Computer Implementation

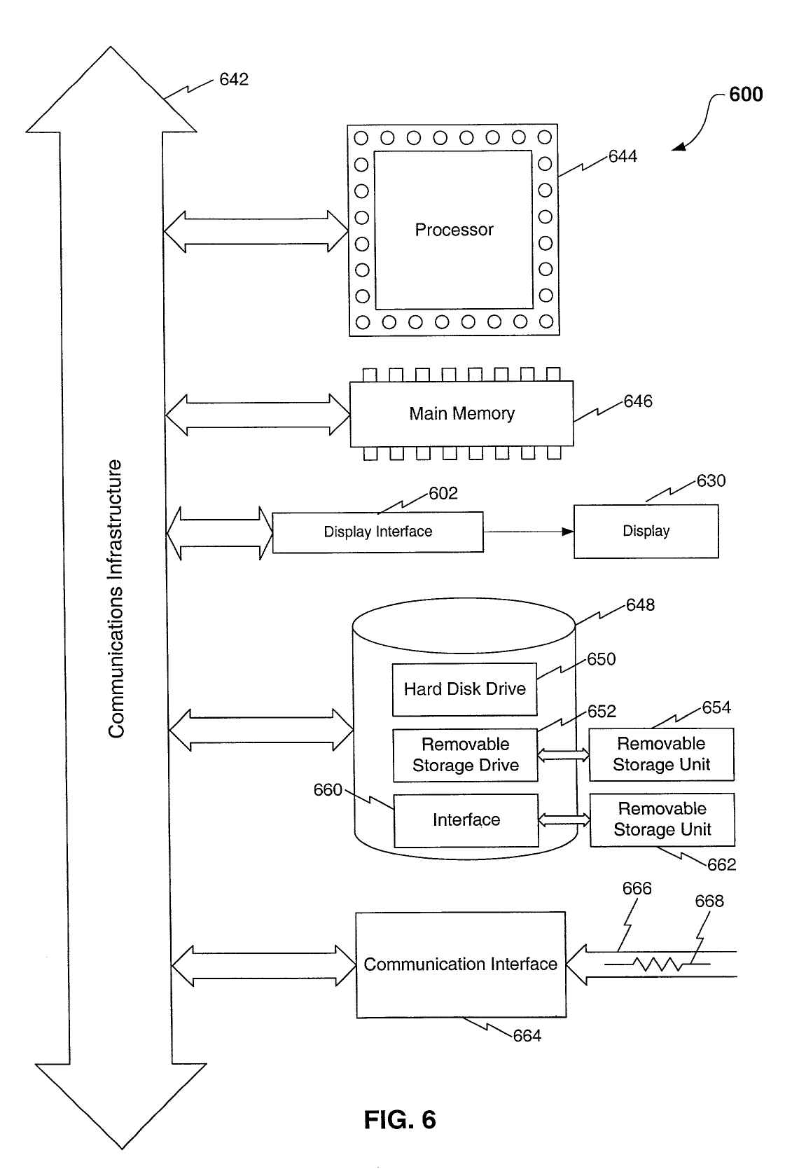

The techniques described above in accordance with the present invention may be implemented using hardware, software or a combination thereof and may be implemented in one or more computer systems or other processing systems. An an example of a computer system 600 that may implement the present invention is shown in FIG. 6. The computer system 600 represents any single or multi-processor computer. In conjunction, single-threaded and multi-threaded applications can be used. Unified or distributed memory systems can be used. Computer system 600, or portions thereof, may be used to implement the present invention. For example, the method for ascertaining three-dimensional camera information from a two-dimensional image described herein may comprise software running on a computer system such as computer system 600. A camera and other broadcast equipment would be connected to system 600.

Computer system 600 includes one or more processors, such as processor 644. One or more processors 644 can execute software implementing the routines described above. Each processor 644 is connected to a communication infrastructure 642 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 600 can include a display interface 602 that forwards graphics, text, and other data from the communication infrastructure 642 (or from a frame buffer not shown) for display on the display unit 630.

Computer system 600 also includes a main memory 646, preferably random access memory (RAM), and can also include a secondary memory 648. The secondary memory 648 can include, for example, a hard disk drive 650 and/or a removable storage drive 652, representing a floppy disk drive, a magnetic tape drive, an optical disk drive, etc. The removable storage drive 652 reads from and/or writes to a removable storage unit 654 in a well known manner. Removable storage unit 654 represents a floppy disk, magnetic tape, optical disk, etc., which is read by and written to by removable storage drive 652. As will be appreciated, the removable storage unit 654 includes a computer usable storage medium having stored therein computer software and/or data.

In alternative embodiments, secondary memory 648 may include other similar means for allowing computer programs or other instructions to be loaded into computer system 600. Such means can include, for example, a removable storage unit 662 and an interface 660. Examples can include a program cartridge and cartridge interface (such as that found in video game console devices), a removable memory chip (such as an EPROM, or PROM) and associated socket, and other removable storage units 662 and interfaces 660 which allow software and data to be transferred from the removable storage unit 662 to computer system 600.

Computer system 600 can also include a communications interface 664. Communications interface 664 allows software and data to be transferred between computer system 600 and external devices via communications path 666. Examples of communications interface 664 can include a modem, a network interface (such as Ethernet card), a communications port, interfaces described above, etc. Software and data transferred via communications interface 664 are in the form of signals which can be electronic, electromagnetic, optical or other signals capable of being received by communications interface 664, via communications path 666. Note that communications interface 664 provides a means by which computer system 600 can interface to a network such as the Internet.

The present invention can be implemented using software running (that is, executing) in an environment similar to that described above with respect to FIGS. 1-5. In this document, the term “computer program product” is used to generally refer to removable storage unit 654, a hard disk installed in hard disk drive 650, or a carrier wave carrying software over a communication path 666 (wireless link or cable) to communication interface 664. A computer useable medium can include magnetic media, optical media, or other recordable media, or media that transmits a carrier wave or other signal. These computer program products are means for providing software to computer system 600.

Computer programs (also called computer control logic) are stored in main memory 646 and/or secondary memory 648. Computer programs can also be received via communications interface 664. Such computer programs, when executed, enable the computer system 600 to perform the features of the present invention as discussed herein. In particular, the computer programs, when executed, enable the processor 644 to perform features of the present invention. Accordingly, such computer programs represent controllers of the computer system 600.

The present invention can be implemented as control logic in software, firmware, hardware or any combination thereof. In an embodiment where the invention is implemented using software, the software may be stored in a computer program product and loaded into computer system 600 using removable storage drive 652, hard disk drive 650, or interface 660. Alternatively, the computer program product may be downloaded to computer system 600 over communications path 666. The control logic (software), when executed by the one or more processors 644, causes the processor(s) 644 to perform functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for deriving three-dimensional camera viewpoint information from a two-dimensional video image of a three-dimensional venue captured by a camera, comprising:
identifying a two-dimensional geometric pattern in the two-dimensional video image;
measuring said two-dimensional geometric pattern; and
calculating the three-dimensional camera viewpoint information using said measurements of said two-dimensional geometric pattern.

2. The method of claim 1, wherein said two-dimensional geometric pattern comprises an ellipse.

3. The method of claim 1, wherein the three-dimensional camera viewpoint information comprises at least one of camera origin, pan, tilt or image distance.

4. The method of claim 3, wherein said camera origin comprises at least one of the camera height above a geometric pattern corresponding to said two-dimensional geometric pattern in the three-dimensional venue or the horizontal distance between the camera and said geometric pattern corresponding to said two-dimensional geometric pattern in the three-dimensional venue.

5. The method of claim 1, further comprising:
providing the three-dimensional camera viewpoint information to a tracking program to track said two-dimensional geometric pattern in subsequently-captured images.

6. The method of claim 1, wherein identifying said two-dimensional geometric pattern comprises:
detecting a candidate two-dimensional geometric pattern in the two-dimensional video image;
generating a hypothetical two-dimensional geometric pattern from said candidate two-dimensional geometric pattern; and
comparing said candidate two-dimensional geometric pattern to said hypothetical two-dimensional geometric pattern;
wherein said two-dimensional geometric pattern is identified as said candidate geometric pattern when said candidate two-dimensional geometric pattern matches said hypothetical two-dimensional geometric pattern.

7. The method of claim 1, wherein said two-dimensional geometric pattern is an ellipse, and wherein said measuring comprises:
measuring the long axis and the short axis of said ellipse.

8. The method of claim 1, wherein said two-dimensional geometric pattern is an ellipse, said three-dimensional camera viewpoint information includes the height of the camera above a circle corresponding to said ellipse in the three-dimensional venue, and wherein said height is calculated according to the formula
h=D* sin θ;
wherein h is said height, D is the distance from the camera to said circle in the three-dimensional venue, and θ is a camera projection angle calculated from the eccentricity of said ellipse.

9. The method of claim 1, wherein said two-dimensional geometric pattern is an ellipse, said three-dimensional camera viewpoint information includes the horizontal distance between the camera and a circle corresponding to said ellipse in the three-dimensional venue, and wherein said horizontal distance is calculated according to the formula
d =D*cos θ;
wherein d is said horizontal distance, D is a distance from the camera to said circle in the three-dimensional venue, and θ is a camera projection angle calculated from the eccentricity of said ellipse.

10. The method of claim 1, wherein said two-dimensional geometric pattern is an ellipse, said three-dimensional camera viewpoint information includes camera tilt, and wherein said camera tilt is calculated according to the formula
T=θ+dt;
wherein T is said camera tilt, θ is a camera projection angle calculated from the eccentricity of said ellipse, and dt is an incremental change in camera tilt motion.

11. The method of claim 1, wherein said two-dimensional geometric pattern is an ellipse, said three-dimensional camera viewpoint information includes camera pan, and wherein said camera pan is calculated according to the formula
P=Φ+dp;
wherein P is said camera pan, Φ is a fixed camera pan angle and dp is an incremental change in camera pan motion.

12. The method of claim 1, wherein said two-dimensional geometric pattern is an ellipse, said three-dimensional camera viewpoint information includes image distance, and wherein said image distance is calculated according to the formula
I=α*D*γ/r;
wherein I is said image distance, α is a measurement of the long axis of said ellipse, D is a distance from the camera to a circle corresponding to said ellipse in the three-dimensional venue, γ is a scalar factor, and r is the radius of said circle in the three-dimensional venue.

13. A method for deriving three-dimensional camera viewpoint information from a two-dimensional video image of a three-dimensional venue captured by a camera, comprising:
identifying an ellipse in the two-dimensional video image;
measuring said ellipse; and
calculating the three-dimensional camera viewpoint information using said measurements of said ellipse.

14. The method of claim 13, wherein said ellipse corresponds to a center circle of a soccer field in the three-dimensional venue.

15. The method of claim 13, wherein the three-dimensional camera viewpoint information comprises at least one of camera origin, pan, tilt or image distance.

16. The method of claim 13, wherein said camera origin comprises at least one of the camera height above a circle corresponding to said ellipse in the three-dimensional venue or the horizontal distance between the camera and said circle in the three-dimensional venue.

17. The method of claim 13, further comprising:
providing the three-dimensional camera viewpoint information to a tracking program to track said ellipse in subsequently-captured images.

18. The method of claim 13, wherein identifying said ellipse comprises:
detecting a candidate ellipse in the two-dimensional video image;
generating a hypothetical ellipse from said candidate ellipse; and
comparing said candidate ellipse to said hypothetical ellipse;
wherein said ellipse is identified as said candidate ellipse when said candidate ellipse matches said hypothetical ellipse.

19. The method of claim 13, wherein said measuring comprises:
measuring the long axis and the short axis of said ellipse.

20. The method of claim 13, wherein said three-dimensional camera viewpoint information includes the height of the camera above a circle corresponding to said ellipse in the three-dimensional venue, and wherein said height is calculated according to the formula
h=D* sin θ;
wherein h is said height, D is the distance from the camera to said circle in the three-dimensional venue, and θ is a camera projection angle calculated from the eccentricity of said ellipse.

21. The method of claim 13, wherein said three-dimensional camera viewpoint information includes the horizontal distance between the camera and a circle corresponding to said ellipse in the three-dimensional venue, and wherein said horizontal distance is calculated according to the formula
d=D* cos θ;
wherein d is said horizontal distance, D is a distance from the camera to said circle in the three-dimensional venue, and θ is a camera projection angle calculated from the eccentricity of said ellipse.

22. The method of claim 13, wherein said three-dimensional camera viewpoint information includes camera tilt, and wherein said camera tilt is calculated according to the formula
T=θ+dt;
wherein T is said camera tilt, θ is a camera projection angle calculated from the eccentricity of said ellipse, and dt is an incremental change in camera tilt motion.

23. The method of claim 13, wherein said three-dimensional camera viewpoint information includes camera pan, and wherein said camera pan is calculated according to the formula
P=Φ+dp;
wherein P is said camera pan, Φ is a fixed camera pan angle and dp is an incremental change in camera pan motion.

24. The method of claim 13, wherein said three-dimensional camera viewpoint information includes image distance, and wherein said image distance is calculated according to the formula
I=α*D*γ/r;
wherein I is said image distance, α is a measurement of the long axis of said ellipse, D is a distance from the camera to a circle corresponding to said ellipse in the three-dimensional venue, γ is a scalar factor, and r is the radius of said circle in the three-dimensional venue.

25. A method for tracking a two-dimensional geometric pattern in a series of two-dimensional video images captured by a camera, comprising:
detecting a two-dimensional geometric pattern in a two-dimensional video image;
verifying said two-dimensional geometric pattern;
measuring said two-dimensional geometric pattern;
calculating the three-dimensional camera viewpoint information using said measurements of said two-dimensional geometric pattern; and
providing the three-dimensional camera viewpoint information to a tracking program to track said two-dimensional geometric pattern.

26. A method for tracking objects in a series of two-dimensional video images captured by a camera, comprising:
detecting an ellipse in a two-dimensional video image;
verifying said ellipse;
measuring said ellipse;
calculating the three-dimensional camera viewpoint information using said measurements of said ellipse; and
providing the three-dimensional camera viewpoint information to a tracking program to track objects in the series of two-dimensional images.

27. A method for tracking a two-dimensional geometric pattern in a series of two-dimensional video images captured by a camera, comprising:
detecting a two-dimensional geometric pattern in a two-dimensional video image;
measuring said two-dimensional geometric pattern;
calculating the three-dimensional camera viewpoint information using said measurements of said two-dimensional geometric pattern; and
providing the three-dimensional camera viewpoint information to a first tracking program, wherein said first tracking program tracks said two-dimensional pattern and refines said three-dimensional camera viewpoint information;
providing said refined three-dimensional camera viewpoint information to a second tracking program for tracking purposes.
